(19) United States
(12) Patent Application Publication
(10) Pub. No.: US 2010/0013789 A1
(43) Pub. Date: Jan. 21, 2010

(54) Touch control liquid crystal display array substrate and a liquid crystal display

(75) Inventors: Te-Chen Chung, KunShan City (CN); Yu-Wen Chiu, KunShan City (CN); Chia-Te Liao, KunShan City (CN)

Correspondence Address: CALFEE HALTER & GRISWOLD, LLP, 800 SUPERIOR AVENUE, SUITE 1400, CLEVELAND, OH, 44114, US

(73) Assignee: InfoVision Optoelectronics (Kunshan) Co. Ltd., KunShan City (CN)

(21) Appl. No.: 12/455,515

(22) Filed: Jun. 3, 2009

(30) Foreign Application Priority Data
Jul. 17, 2008 (CN) 200810134185.X

(51) Int. Cl. G06F 3/044

(52) U.S. Cl. 345/174; 349/48

(57) ABSTRACT

A touch control liquid crystal display includes an array substrate which comprises scan lines, data lines perpendicular to the scan lines and further defining a pixel area, a pixel electrode formed in the pixel area, a storage capacitor electrode forming a first storage capacitor with the pixel electrode, a first switching element through which the data line inputs data signals to the pixel electrode, a signal detecting line, a touch control electrode forming a second storage capacitor with the storage capacitor line, a second switching element through which the signal detecting line inputs or outputs a voltage signal to the touch control electrode, a converter for controlling the output or input of the voltage signal on the signal detecting line.

### CROSS-REFERENCE TO RELATED APPLICATION

This application claims priority to prior Chinese Application Serial No. 200810134185.X, filed Jul. 17, 2008, the disclosure of which is hereby incorporated herein by reference in its entirety.

1. Field of the Invention

The present invention relates to a liquid crystal display array substrate and a liquid crystal display, and in particular, this invention relates to a touch control liquid crystal display panel and a liquid crystal display using the same.

2. Background of the Invention

As technology evolves, digital tools such as mobile phones, personal digital assistants (PDAs) and laptops are developed to be more convenient to operate. These digital tools are developed with multiple functions as well as to have a beautiful appearance. A display screen is an indispensible interface between human beings and digital tools. At present, liquid crystal displays are most commonly employed as the display screen.

In recent years, wireless mobile communication and household appliances that communicate information have developed faster and faster. Many products that communicate information have adopted touch panels as the input device instead of traditional input devices, such as keyboards or mice, to achieve the object of being more convenient, much more compact and more humanized. As such, the touch control liquid crystal displays are becoming mainstream.

A touch control liquid crystal display controls the display of the liquid crystal display by detecting whether there is an external force or signal applied on the liquid crystal display and detecting a location signal (hereafter referred to as the “coordinate”) that indicates where the external force is applied on the liquid crystal display.

Until now touch panel control has been achieved by employing different kinds of touch control technology such as capacitors, resistors, sound waves, infrared and so on. In general, the most commonly adopted touch control liquid crystal display is a liquid crystal display panel, on the surface of which there is provided a touch control panel.

### SUMMARY OF THE INVENTION

Embodiments of the present invention is to provide a touch control liquid crystal display array substrate with decreased weight, small thickness and low cost as well as high display luminance, and a liquid crystal display.

In one exemplary embodiment, a touch control liquid crystal display array substrate comprises a plurality of scan lines, a plurality of data lines perpendicular to the plurality of scan lines and further defining a pixel area, a pixel electrode formed in the pixel area, a storage capacitor electrode forming a first storage capacitor with the pixel electrode, a first switching element through which the data line inputs data signal to the pixel electrode, wherein the array substrate further comprises: a signal detecting line, a touch control electrode formed in the pixel area and forming a second storage capacitor with the storage capacitor, a second switching element through which the signal detecting line inputs or outputs a voltage signal to the touch control electrode, a converter for controlling the output or input of the voltage signal on the signal detecting line.

A touch control liquid crystal display may include an array substrate, a color filter substrate and a peripheral circuit, wherein the array substrate comprises: a plurality of scan lines, a plurality of data lines perpendicular to the plurality of scan lines and further defining a pixel area, a pixel electrode formed in the pixel area, a storage capacitor electrode forming a first storage capacitor with the pixel electrode, a first switching element through which the data line inputs data signal to the pixel electrode, wherein the array substrate further comprises: a signal detecting line, a touch control electrode formed in the pixel area and forming a second storage capacitor with the storage capacitor, a second switching element through which the signal detecting line inputs or outputs a voltage signal to the touch control electrode, the color filter substrate includes a contraposition electrode, the peripheral circuit further comprises a converter for controlling the output or input of the voltage signal on the signal detecting line.

### BRIEF DESCRIPTION OF THE DRAWINGS

The above and other features and advantages of the invention will become more apparent to those of ordinary skill in the art by describing in detail exemplary embodiments thereof with reference to the attached drawings. The same drawing references refer to the same elements.

### Wherein:

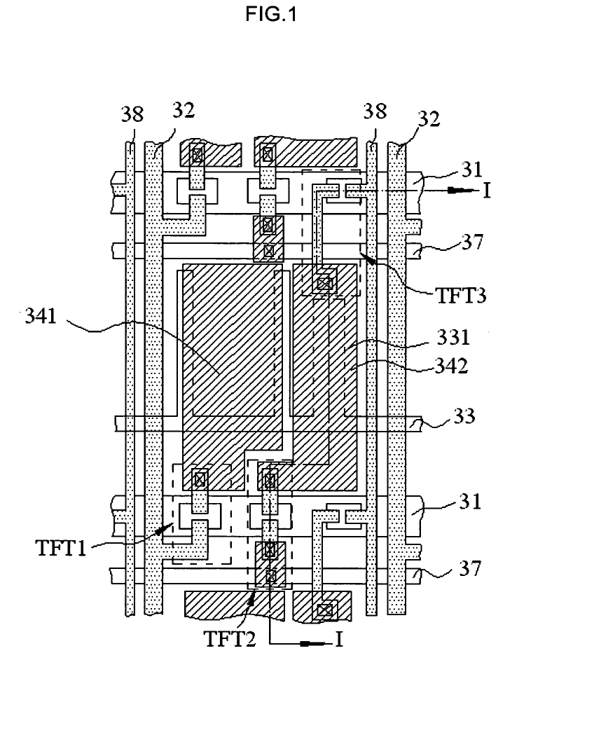

FIG. 1 is a schematic view illustrating pixel structure according to a first exemplary embodiment of the present invention;

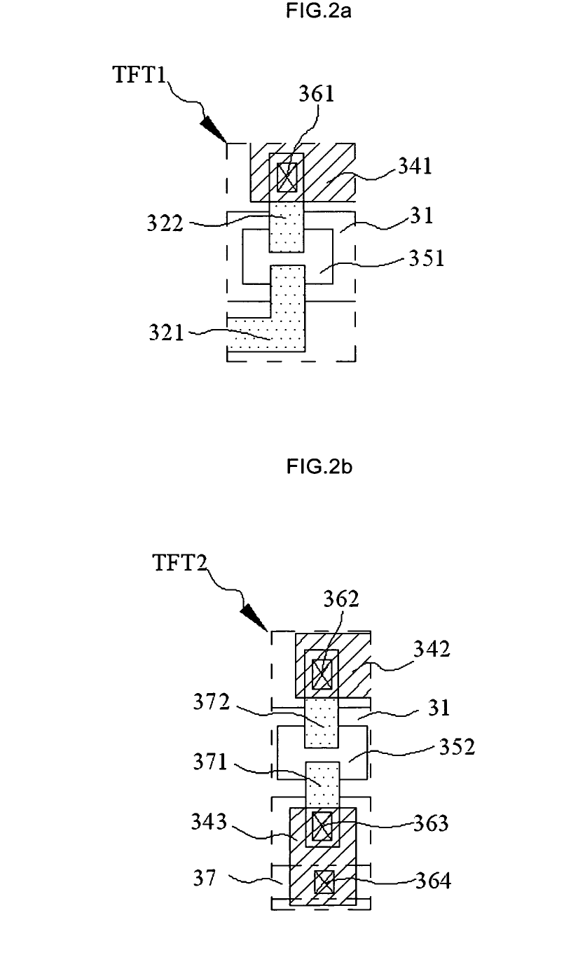

FIG. 2a is an enlarged partial view of FIG. 1 showing a first thin film transistor TFT1;

FIG. 2b is an enlarged partial view of FIG. 1 showing a second thin film transistor TFT2;

FIG. 2c is a zoomed partial view of FIG. 1 showing a third thin film transistor TFT3;

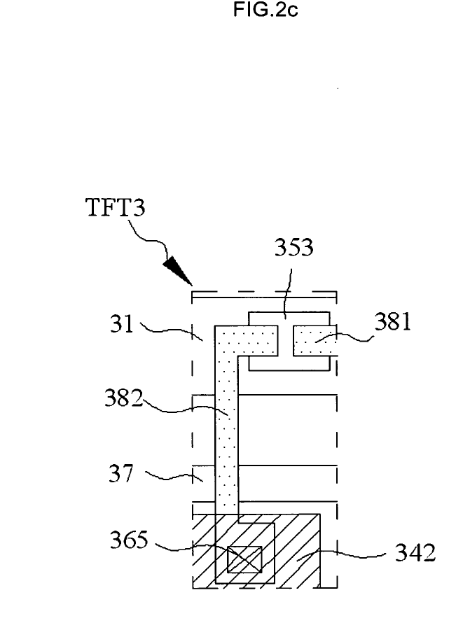

FIG. 3 is a cross-sectional view along the cut-off line I-I in FIG. 1;

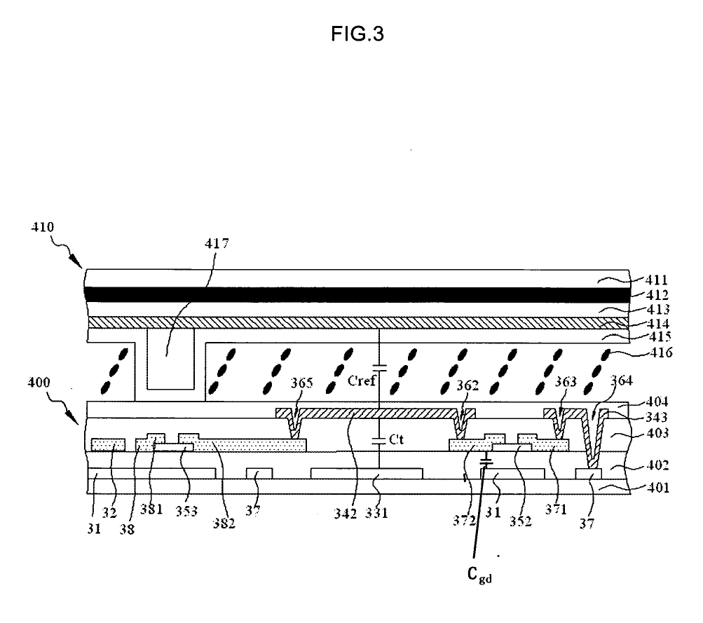

FIG. 4 is a schematic view showing the circuit in the structure illustrated in FIG. 1;

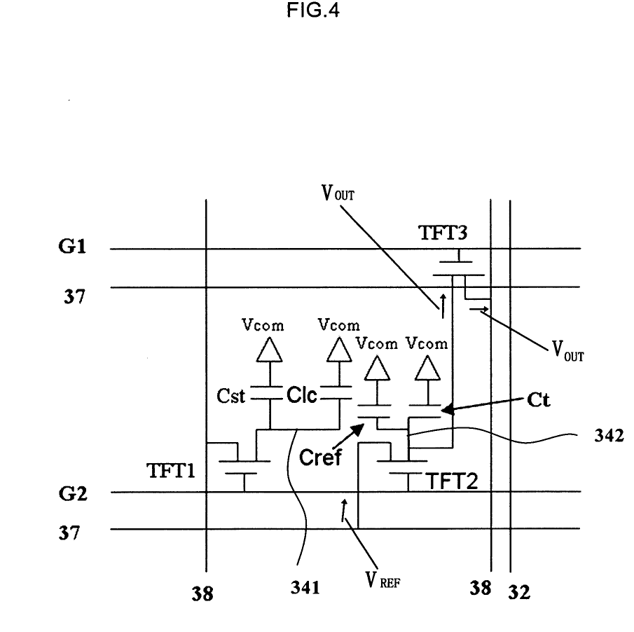

FIG. 5 illustrates the operational steps of a detector located outside of the display area;

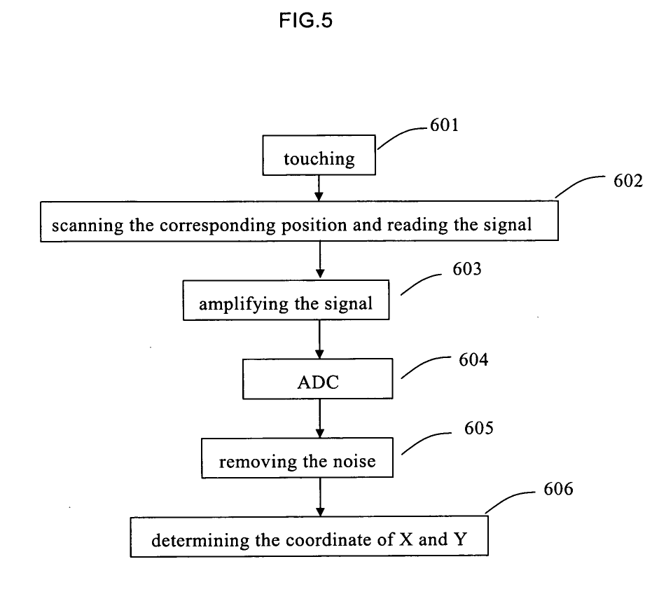

FIG. 6 is a schematic view illustrating a pixel structure according to a second exemplary embodiment of the present invention;

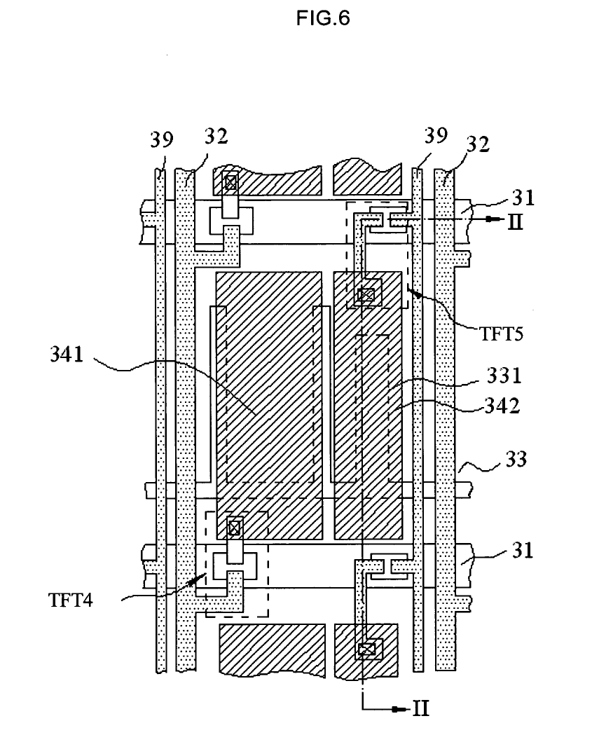

FIG. 7a is an enlarged partial view of FIG. 6 showing a first thin film transistor TFT4;

FIG. 7b is an enlarged partial view of FIG. 6 showing a second thin film transistor TFT5;

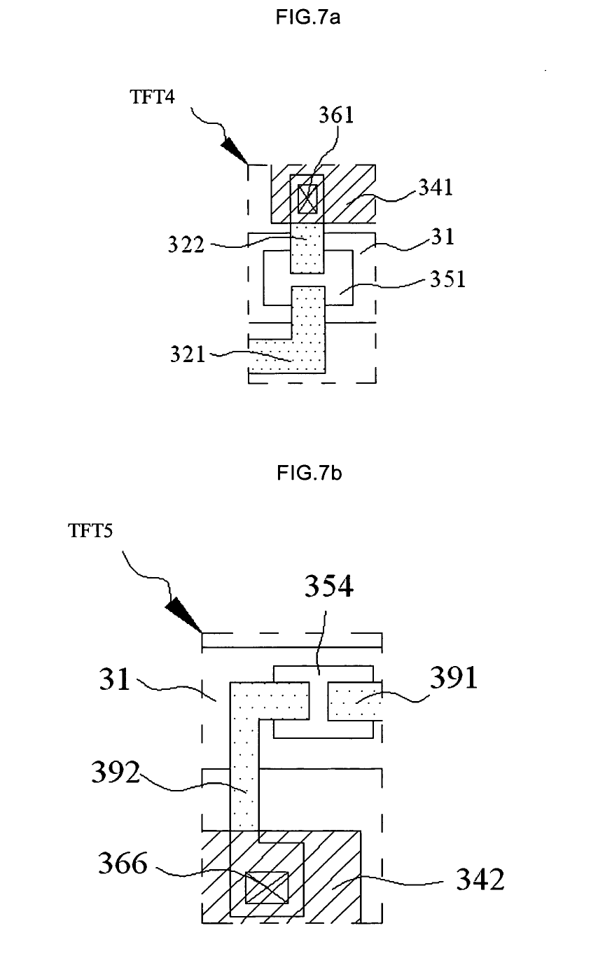

FIG. 8 is a cross-sectional view along the cut-off line I-I in FIG. 6;

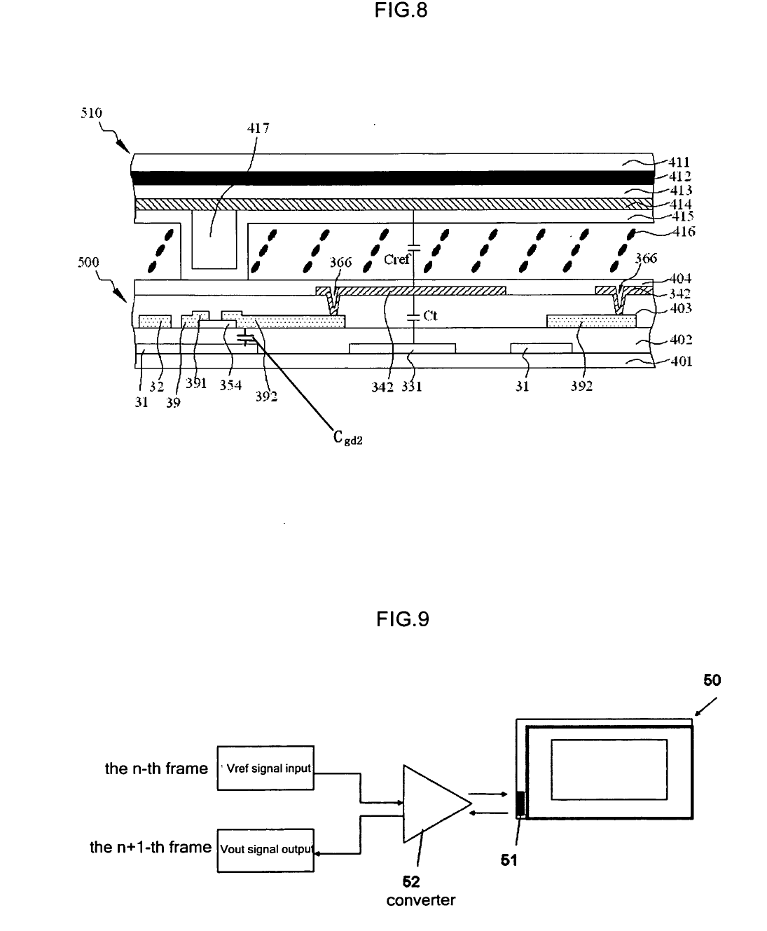

FIG. 9 is a peripheral signal control circuit.

### DETAILED DESCRIPTION OF THE INVENTION

Embodiments of the present invention will now be described more fully with reference to the accompanying drawings, in which exemplary embodiments of the invention are shown. According to one or more of the exemplary embodiments presented below, the function of touch control is incorporated into a display array substrate, while a separate touch panel is not needed, so that the weight and thickness of the display is decreased and the costs is therefore deduced while a high display luminance is obtained.

FIG.1 is a schematic view illustrating a pixel structure according to a first embodiment of the present invention. For the sake of clarity, a color filter substrate is omitted from the drawing. In FIG. 1, the reference number 31 represents a scan line, the reference number 32 represents a data line, the reference number 33 represents a storage capacitor electrode line and the reference number 331 represents an extension portion of storage capacitor electrode line. Scan line 31 is arranged to be perpendicularly crossed with data line 32 so as to define a pixel area, in which a pixel electrode 341 is formed. The pixel electrode 341 and the storage capacitor electrode line 33 form a first storage capacitor Cₛₜ, (schematically illustrated in FIG. 4). The pixel electrode 341 and a contraposition electrode (referring to FIG. 3) on the color filter substrate form a liquid crystal capacitor C_{lc} (schematically illustrated in FIG. 4). A first thin film transistor TFT1 is provided at the crossing of the scan line 31 and the data line 32.

FIG. 2a is an enlarged partial view of FIG. 1 showing the first thin film transistor TFT1. As shown in FIG. 2a, the first thin film transistor TFT1 comprises, a gate electrode, a source electrode 321 and a drain electrode 322 as well as a semiconductor layer 351, wherein the gate electrode is electrically connected to the scan line 31 (the gate electrode shown in the drawing is a part of the scan line 31), the source electrode 321 is electrically connected to the data line 32, and the drain electrode 322 is electrically connected to the pixel electrode 341 via a through hole 361.

In the embodiments of the present invention, a reference voltage input line 37 is provided at a position, which is parallel to the scan line 31 and a signal detecting line 38 is provided at the position parallel to the data line 32. A touch control electrode 342 is also arranged in the pixel area. The touch control electrode 342 together with the storage capacitor electrode line 33 forms a second storage capacitor Cₜ (See FIGS. 3 and 4). To increase the capacity of the storage capacitor Cₜ, the extension portion 331 is provided on the storage capacitor electrode line 33 and under the touch control electrode 342. Of course an auxiliary metal layer can also be provided between the storage capacitor electrode line 33 and the touch control electrode 342. This optional auxiliary metal layer may be electrically connected to the touch control electrode via a through hole. A second thin film transistor TFT2 is provided above the reference voltage input line 37 and a third thin film transistor TFT3 is provided at the position where the signal detecting line 38 intersects the scan line 31.

FIG. 2b is an enlarged partial view of FIG. 1 showing the second thin film transistor TFT2. As shown, the second thin film transistor TFT2 includes a gate electrode, a source electrode 371, a drain electrode 372 and a semiconductor layer 352, wherein the gate electrode is electrically connected to the scan line 31 (the gate electrode shown in the drawing is a part of the scan line 31), and the source electrode 371 is electrically connected to a connecting electrode 343 via a through hole 363. The reference voltage input line 37 is electrically connected to the connecting electrode 343 via a through hole 364. Therefore, the source electrode 371 may be electrically connected to the reference voltage input line 37 through the connecting electrode 343 and the drain electrode 372 may be connected to the touch control electrode 342 via a through hole 362.

FIG. 2c is an enlarged partial view of FIG. 1 showing the third thin film transistor TFT3. As shown, the third thin film transistor TFT3 includes a gate electrode, a source electrode 381, a drain electrode 382 and a semiconductor layer 353. The gate electrode is electrically connected to the scan line 31 (the gate electrode shown in the drawing is a part of scan line 31), the source electrode 381 is electrically connected to the signal detecting line 38, the drain electrode 382 is electrically connected to the touch control electrode 342 via a through hole 365.

FIG. 3 is a cross sectional view along the cut-off line I-I in FIG. 1. As shown, the reference number 400 represents an array substrate which comprises a glass substrate 401, on which a scan line 31, a reference voltage input line 37, as well as a storage capacitor electrode line extension portion 331 are formed. A gate insulting layer 402 covers the scan line 31, the reference voltage input line 37, as well as the storage capacitor electrode line extension portion 331. Above the gate insulting layer 402 at the position corresponding to the scan line 31, there provided semiconductor layers 352 and 353. Above the semiconductor 352, there are provided a source electrode 371 and a drain electrode 372 of the second thin film transistor TFT2. The source electrode 381 and the drain electrode 382 of the third thin film transistor TFT3 are provided above the semiconductor layer 353. At the same layer as the source electrodes and drain electrodes of the second thin film transistor TFT2 and the third thin film transistor TFT3, there are also provided a data line 32, as well as a signal detecting line 38. Above the source electrodes and drain electrodes of the second thin film transistor TFT2 and the third thin film transistor TFT3, as well as the data line 32 and the signal detecting line 38, there covers a passivation layer 403. A touch control electrode 342, a connecting electrode 343, and a pixel electrode 341 (see FIGS. 1 and 2A) are formed above the passivation layer. Furthermore, the touch control electrode 342 is electrically connected to the drain electrode 372 of the second thin film transistor TFT2 and the drain electrode 382 of the third thin film transistor TFT3 via two through holes 362 and 365. A connecting electrode 343 is electrically connected to the source electrode 371 of the second thin film transistor TFT2 and a reference voltage input line 37 via through holes 363 and 364. Therefore, the source electrode 371 and the reference voltage input line 37 may be electrically connected with each other through the connecting electrode 343. All layers are covered by an alignment layer 404.

The scan lines 31, data lines 32, and the pixel electrode 341 may be made in the same manner as scan lines, data lines and pixel electrodes of known liquid crystal displays. Further, the scan lines 31, data lines 32, and pixel electrodes 341 may be made using any processes and/or materials that are used to make known liquid crystal displays. In the present embodiment, the reference voltage input line 37 may be formed using the same process as the scan line 31 and can be made of the same materials. The signal detecting line 38 may be formed in the same process as the data line 32 and can be made of the same materials. Similarly, the touch control electrode 342, and/or the connecting electrode 343 may be formed in the same process as the pixel electrode 341 and be made of the same materials, such as transparent conductive material, for example Indium Tin Oxide (ITO). Hence, forming the structure as described in the present embodiment will not increase the number of procedures that need to be performed to construct the display.

The reference number 410 represents a color filter substrate, which may comprise a glass substrate 411. On the glass substrate, formed sequentially are the black matrix 412, the color filter layer, the protection layer 413, the contraposition electrode 414, and the spacer 417. The color filter layer is located in the area which corresponds to the pixel electrode 341 and the black matrix 412 covers the area outside of the pixel area. In this regard, the area corresponding to the touch control electrode is also covered by the black matrix 412. All layers are covered by alignment layer 415.

The array substrate 400 and the color filter substrate 410 are spaced apart by a spacer, so as to keep a certain distance with respect to one another. The liquid crystal layer 416 is provided between the array substrate 400 and the color filter substrate 410.

As shown in FIG. 3, the extension portion 331 of the storage capacitor electrode line and the touch control electrode 342, which are spaced by the gate insulating layer 402 and the passivation layer 403, form a second storage capacitor Cₜ. The contraposition electrode 414 and the touch control electrode 342, which are spaced by the liquid crystal layer 416 and alignment layers 404, 415, form a reference voltage capacitor C_{ref}. Furthermore, the gate electrode and the drain electrode 372 of the second thin film transistor TFT2, which are spaced by the gate insulating layer 402, form a parasitic capacitor C_{gd}.

FIG. 4 is a schematic view showing the circuit of single pixel structure illustrated in FIG. 1. As shown, the drain electrode of the first thin film transistor TFT1 is electrically connected to the pixel electrode 341, and the pixel electrode 341 forms the first storage capacitor Cₛₜ, and a liquid crystal capacitor C_{lc}, receptively, with the storage capacitor electrode line 33 and the contraposition electrode 414. The drain electrode of the second thin film transistor TFT2 is electrically connected to the touch control electrode 342, and the touch control electrode 342 forms the second storage capacitor Cₜ and a reference capacitor C_{ref} respectively with the extension portion 331 of storage capacitor electrode line and the contraposition electrode. In an exemplary embodiment, the input on the storage capacitor electrode line 33 (the extension portion 331 of storage capacitor electrode line) and the contraposition electrode 414 are all common voltage signal V_{com}. For clarity, the scan line above the pixel electrode is identified by reference character G1, and the scan line under the pixel electrode is identified by reference character G2.

In normal operation of the embodiments of the liquid crystal displays disclosed herein, the scan line G1 and the G2 are sequentially scanned at the time of the n-th frame. When the scan line G2 is scanned, it is at a high level, and the first thin film transistor TFT1, as well as, the second thin film transistor TFT2 are turned on. The data signal 32 is transferred to the pixel electrode through the first thin film transistor TFT1, and the first storage capacitor Cst together with the liquid crystal capacitor Clc are charged. The reference voltage input line 37 inputs a reference voltage V_{ref} onto the touch control electrode 342 through the second thin film transistor TFT2, and charges the second storage capacitor Cₜ and the reference capacitor C_{ref}. When the scan line G2 finishes the scan and is at a low level state, the first thin film transistor TFT1 and the second thin film transistor TFT2 are turned off. At the time the scan line finishes, the voltage on the pixel electrode is sustained by the first storage capacitor Cₛₜ, and the voltage on touch control electrode 342 is sustained by the second storage capacitor Cₜ. At the time of the n+1th frame, when the scan line G1 is scanned to be at a high level state, then the third thin film transistor TFT3 is turned on. The voltage sustained on the touch control electrode is transferred to the signal detecting line 38 through the third thin film transistor TFT3, and then a detector (not shown) detects the voltage signal (or the amplified voltage signal). The detector may take a wide variety of different forms and may be positioned at a wide variety of different locations on the display. Any detector, capable of detecting a presence of and/or magnitude of the signal from the third transistor TFT3 may be used. The voltage (described as a detecting voltage, because this voltage may be used for detecting a user input) transferred over signal detecting line 38 is the voltage sustained on the touch control electrode, hereafter referred to as Vₒᵤₜ.

Due to the influence of the parasitic capacitance C_{gd} between the drain electrode and gate electrode of the second thin film transistor TFT2, the voltage Vₒᵤₜ sustained on the touch control electrode by the second storage capacitor Cₜ decreases relative to the inputted reference voltage V_{ref} after the second thin film transistor TFT2 is turned off. Generally, the relationship of voltage Vₒᵤₜ sustained on the touch control electrode and the voltage V_{ref} input from the reference voltage input line 37 is expressed as follow:

Vₒᵤₜ=V_{ref}−Δ Vgh·cgd/(cref+ct+cgd) (1)

wherein Δ Vgh is the absolute value of the voltage difference between the high level and low level applied on the scan line. In general, both the high level and low level are predetermined values, and therefore the absolute value Δ Vgh of their voltage difference is a fixed value.

cgd represents the capacitance value of the parasitic capacitor C_{gd} between the gate electrode and drain electrode of the second thin film transistor TFT2. The dielectric constant ε of the dielectric layer (gate insulating layer) corresponding to the parasitical capacitor, the area s of the part in which both of these two electrodes face each other, as well as the distance therebetween are fixed. Also, the voltage of the gate electrode and the voltage of the drain electrode of the second thin film transistor are also fixed. Therefore the capacitance value cgd of the parasitic capacitor C_{gd} is also a fixed value.

ct represents the capacitance value of the second capacitor Cₜ between the extension portion 331 of the storage capacitor electrode line and the touch control electrode 342. The dielectric constant ε of the dielectric layer (gate insulating layer and the passivation layer) corresponding to the second capacitor Cₜ, the area s of the part in which both of these two electrodes face each other as well as the distance there between are fixed. Also, the voltages on the touch control electrode and extension portion 331 of the storage capacitor electrode line are also fixed under normal condition (that is the condition that no outside force is applied to the liquid crystal panel). Therefore the capacitance value Cₜ of the capacitor Cₜ is also a fixed value under the normal condition.

cref represents the capacitance value of the reference capacitor C_{ref} between the touch control electrode 342 and the contraposition electrode 414. Its dielectric layer is the alignment layers 404, 415 as well as the liquid crystal layer 416. Here, the voltages on the touch control electrode 342 and the extension portion 331 of the contraposition electrode 414 are also fixed under the normal condition (that is the condition that no external force is applied to the liquid crystal panel). Therefore, the capacitance value c_{ref} of the capacitor C_{ref} is also a fixed value under the normal condition.

Under the normal condition, no external force is applied to the color filter substrate. Therefore, the distance between the color filter and the array substrate remains unchanged because of the spacer 417. Hence, the capacitance value cgd of the parasitical capacitor C_{gd}, the capacitance value cref of the reference capacitor C_{ref} and the capacitance value ct of the storage capacitor Cₜ are all fixed in the normal condition. It can be seen from expression (1) that, when all of the values are fixed, the detecting voltage Vₒᵤₜ (i.e. the voltage sustained by the touch control electrode) output by the signal detecting line 38 is also fixed. In this regard, the value that is detected by the peripheral detector (not shown) is also a normal value Vₒᵤₜ (or an amplified voltage signal).

Referring to FIG. 3, when an external force is applied to the color filter substrate, the distance between the portion of the color filter substrate where the force is applied and the array substrate becomes smaller and the value of the reference capacitor C_{ref} increases. With reference to expression (1), when the value of the reference capacitor C_{ref} increases, the voltage sustained on the touch control electrode (here referred as Vₒᵤₜ′) also increases. Hence, when the scan line G1 is scanned, the third thin film transistor TFT3 is turned on. The voltage sustained on the touch control electrode 342 is transmitted to the signal detecting line 38 through the third thin film transistor TFT3, while the peripheral detector detects a abnormal or increased voltage signal Vₒᵤₜ′ (or a amplified voltage signal).

Because the scan lines are scanned sequentially, and the detector can detect the output signal through signal detecting line 38 only when the scan line G1 is turned on, so when the abnormal or increased voltage signal is detected, the coordinate position where the external force is applied to the color filter substrate can be determined (the row where the scan line is located is the abscissa and the column where the signal detecting line is located is the ordinate).

FIG. 5 illustrates the operation steps of the detector, which may be located outside of the display area. It should be recognized that the steps may be performed in an order other than as shown in FIG. 5 and described below and that one or more of these steps may be omitted. In the method illustrated by FIG. 5, the panel is touched (i.e. an external force is applied to the panel (step 601). Then the detecting voltage signal on the signal detecting line is read (step 602). Then, the detecting voltage signal may optionally be amplified (step 603). Then, analog-digital conversion may optionally be performed (step 604) and noise may be removed (step 605). This allows the coordinates of the location where the touching occurs to be determined (step 606).

It can be seen from the present embodiment that since the reference capacitance C_{ref} is changed by altering the distance between the array substrate and the color filter substrate, the voltage sustained on the touch control electrode (that is the detecting voltage) will be changed accordingly. Therefore it can be determined whether there is any external force applied on the liquid crystal panel by detecting the detecting voltage, and furthermore, the coordinate of the location where the external force is applied can also be determined.

Those skilled in the art will understand that, when an external force is applied, the sensitivity of detecting the outside force on the touch control liquid crystal display can be increased by increasing the amount the capacitance of the reference capacitor C_{ref} changes as a result of the touching. Therefore, in an exemplary embodiment, the distance between the touch control electrode 342 and the contraposition electrode 414 may be decreased. For example, a protuberance may be provided at the position on the color filter corresponding to the touch control electrode and the contraposition electrode 414 may further be provided on the protuberance, so that the distance between the contraposition electrode and the touch control electrode 342 is decreased. The distance between the contraposition electrode 414 and the touch control electrode 342 can also be decreased by providing the protuberance under the touch control electrode on the array substrate. Of course, this can also be achieved by other means. For example, any manner of making the distance between the contraposition electrode and the touch control electrode smaller than the distance between the pixel electrode and the contraposition electrode may be employed.

Those skilled in the art will understand that the arrangement and/or relation of the reference voltage input line 37 and the signal detecting line 38 is illustrative, wherein the reference voltage input line 37 can also be arranged to be parallel to the data line, while the signal detecting line 38 can also be provided to be parallel to the scan line. Further, or both reference voltage input line and signal detecting line are arranged to be parallel to the data line or the scan line. Any arrangement may be employed.

In the present embodiment, the number of the detecting points for determining the external force or touching (i.e. the pixels correspond to the signal detecting line 39 and touch control electrode) can be provided as required. That is, they can be disposed all over the whole panel, or only disposed in some pixels, some pixel rows or some pixel columns. However, to guarantee the display quality of the whole panel, the aperture ratio of every pixel is kept the same in an exemplary embodiment. That is, some pixel areas may be covered by the black matrixes because there are touch control electrodes disposed at these pixel areas. As a result of that, the aperture ratio of these areas decreases. On the other hand, although the control electrodes are not included in other pixels, these other pixels are also covered by the black matrixes. This ensures that the aperture ratio of the pixels which include touch control electrodes is the same as the aperture ratio of the pixels which do not include touch control electrodes.

In the above embodiment, because the reference voltage input line 37 and the signal detecting line 38 are both included, the function of the touch control liquid crystal display can be achieved. However, the aperture ratio of the pixels may be decreased significantly by including both a voltage input line 37 and a signal detecting line 38. Further, to achieve the aforesaid touch control function, the second thin film transistor TFT2 and the third thin film transistor are included in the FIG. 1 embodiment. It can be seen from FIG. 1 that on the scan line, one area pixel area includes three thin film transistors, which may lead to a heavy load of the whole scan line and could potentially result in signal delay.

Hereafter a second embodiment of the present invention will be described with reference to FIG. 6 to FIG. 9.

FIG. 6 is a schematic view illustrating a pixel structure according to a second exemplary embodiment of the present invention. To show the structure of the pixel clearly, the color filter substrate is omitted from the drawing. As shown, 31 is the scan line, 32 is the data line and 33 is the storage capacitor electrode line, 331 is the extension portion of storage capacitor electrode line 33. The scan line 31 intersects the date line 32 perpendicularly defines a pixel area, that the pixel electrode 341 forms. The pixel electrode 341 and the storage capacitor electrode line 33 form a first storage capacitor Cₐₜ as described above. At the position where the scan line 31 intersects the data line 32 a first switching element is provided. The first switching element, such as thin film transistor TFT4, has the same structure as the first thin film transistor as shown in the first embodiment. FIG. 7a is an enlarged partial view of FIG. 6 illustrating the thin film transistor TFT4. As shown, thin film transistor TFT4 may comprises the gate electrode, the source electrode 321, the drain electrode 322 and the semiconductor layer 351. The gate electrode is electrically connected to the scan line 31 (the gate electrode as shown in the drawing is a part of the scan line 31), the source electrode 321 is electrically connected to the data line 32, and the drain electrode 322 is electrically connected to the pixel electrode 341 via a through hole 361.

In exemplary embodiments of the present invention, signal detecting line 39, as well as a touch control electrode 342, are provided at a position parallel to the data line 32 (see FIG. 6). The detecting line 39, as well as the touch control electrode 342, form the second storage capacitor Cₜ with the storage capacitor electrode line 33. To increase the capacitance of the storage capacitor, there is also provided an extension portion 331 on the storage capacitor electrode line 33 and the extension portion 331 is disposed under the touch control electrode. Of course an auxiliary metal layer could also be disposed between the storage capacitor electrode line and the touch control electrode and the auxiliary metal layer is electrically connected to the touch control electrode via a through hole.

The second switching element is disposed at the position where the signal detecting line 39 intersects scan line 31. The second switching element can be a thin film transistor TFT5, as shown in FIG. 7b. FIG. 7b is an enlarged partial view of FIG. 6 showing the thin film transistor TFT5. As shown, thin film transistor TFT5 comprises a gate electrode, a source electrode 391, a drain electrode 392 and a semiconductor layer 354. The gate electrode is electrically connected to the scan line 31 (the gate electrode as shown in the drawing is a part of the scan line 31), the source electrode 391 is electrically connected to the signal detecting line 39, and the drain electrode 392 is electrically connected to the touch control electrode 342 via a through hole 366.

FIG. 8 is a cross-sectional view along the cut-off line I-I in FIG. 6. As is shown, 500 is an array substrate, this array substrate comprises a glass substrate 401, on which the scan line 31, and the extension portion 331 of the storage capacitor electrode line are formed. The gate insulating layer 402 covers the scan line 31 as well as the extension portion 331 of the storage capacitor electrode line. Above the gate insulating layer 402, at the position corresponding to the scan line 31, there is provided a semiconductor layer 354. Above the semiconductor 354, there are provided the source electrode 391 and the drain electrode 392 of thin film transistor TFT5. The source electrode 391 and drain electrode 392 of thin film transistor TFT5 are provided above the semiconductor layer 353. On the same layer as the source electrodes and drain electrodes of thin film transistor TFT5 there is also provided the data line 32, as well as the signal detecting line 39. Above the source electrodes and drain electrodes of thin film transistor TFT5, as well as the data line 32 and the signal detecting line 39, there covers a passivation layer 403. All layers are covered by the alignment layer 404. In the present embodiment, the signal detecting line 39 may be formed using the same process as the data line and can be made of the same materials. Similarly, the touch control electrode 342 may be formed using the same process as pixel electrode and can be made of the same materials, such as transparent conductive material ITO. Hence, forming the structure as mentioned in the present embodiment will not increase the number of procedures needed to construct the liquid crystal display.

510 is the color filter substrate, which comprises the glass substrate 411. On the glass substrate the black matrix 412, the protection layer 413 and the contraposition electrode 414 and the spacer 417 (wherein color filter layer 412 is located in the area which corresponds to pixel electrode 341, therefore not shown) are sequentially formed. All layers are covered by the alignment layer 415.

The array substrate 500 and the color filter substrate 510 are spaced apart by a spacer, so as to keep a certain distance between each other. The liquid crystal layer 416 is provided between the array substrate 500 and the color filter substrate 510.

As shown in FIG. 8, the extension portion 331 of the storage capacitor electrode line and the touch control electrode 342, which are spaced by the gate insulating layer 402 and the passivation layer 403, form a second storage capacitor Cₜ. The contraposition electrode 414 and the touch control electrode 342, which are spaced by the liquid crystal layer 416 and the alignment layers 404, 415, form a reference voltage capacitor C_{ref}. Furthermore, the gate electrode and drain electrode 392 of thin film transistor TFT5, which are spaced by a gate insulating layer 402, form a parasitic capacitor C_{gd2}.

In comparison with the first embodiment, no reference voltage input line (reference number 37 in the first embodiment) is included in the present embodiment, but only the signal detecting line 39 is provided here. Now the principle of the second embodiment will be described with reference to FIGS. 6, 8 and 9 FIG. 9 shows a peripheral signal control circuit. The peripheral pin 51 is disposed peripherally on the liquid crystal display panel 50, which is electrically connected to the signal detecting line 39 (as shown in FIG. 6). It should be noted that the number of the peripheral pins 51 may correspond to the number of signal detecting lines 39. A converter 52 is connected to the peripheral pin 51 for controlling the signal input or output of the signal detecting line 39. Exemplary converters are well known in the art. For example, two transistors can be adopted to control the output or input of the signal, wherein when the transistor used for controlling the input of the signal is turned on, the transistor used for controlling the output of the signal is turned off. Similarly, when the transistor used for controlling the output of the signal is turned on, the transistor used for controlling the input of the signal is turned off. The convertor can also be implemented by other electrical elements and their known working principles. In one exemplary embodiment, the converter operates as follows: at the time of the n-th frame, the converter 52 selectively inputs the reference voltage V_{ref}, and the peripheral driving circuit can input the reference voltage V_{ref} onto the signal detecting line 39 through the peripheral pin 51. With reference to FIG. 6, when the scan line 31 is scanned to be in high level state during the n-th frame, the thin film transistor TFT5 on this scan line is turned on. Therefore, the reference voltage V_{ref} signal on the signal detecting line 39 can be transmitted to the corresponding touch control electrode through the thin film transistor TFT5 and simultaneously the second storage capacitor Cₜ as well as the reference capacitor C_{ref} is charged. Due to the second storage capacitor Cₜ and the reference capacitor, the voltage on the touch control electrode 342 can be sustained when this scan line is in low level state (that is, thin film transistor TFT5 is turned off).

At the time of the n+1th frame, the converter 52 selects the detecting voltage. Therefore, when the scan line 31 is scanned to be in high level state during the n+1-th frame, thin film transistor TFT5 on this scan line is turned on. Therefore, the voltage signal sustained on the touch control electrode 414 corresponding to this thin film transistor TFT5 can be transmitted to the signal detecting line 39 through the thin film transistor TFT5 and be transmitted to the detector (the operation principle and the structure of the detector are known in the art and are not the emphasis of the present invention, so the detector will not be described in detail here) through the peripheral pin 51 and the converter 52. The outputted detecting voltage is detected by the detector. The detecting voltage is the voltage sustained on the touch control electrode, hereafter referred to as Vₒᵤₜ.

Due to the influence of the parasitic capacitance C_{gd2} between the drain electrode and gate electrode of thin film transistor TFT5, the voltage Vₒᵤₜ sustained on the touch control electrode by the second storage capacitor Cₜ decreases after the thin film transistor TFT5 is turned off. Generally, the relationship of voltage Vₒᵤₜ sustained on the touch control electrode and the voltage V_{ref} inputting from the signal detecting line 39 is expressed as follow:

Vₒᵤₜ=V_{ref}−Δ Vgh·cgd/(cref+ct+cgd) (2)

wherein Δ Vgh is the absolute value of the voltage difference between the high level and low level applied on the scan line. In general, both the high level and low level are predetermined values, and therefore the absolute value Δ Vgh of their voltage difference is a fixed value.

cgd2 represents the capacitance value of the parasitic capacitor C_{gd2} between the gate electrode and drain electrode of film transistor TFT5. The dielectric constant ε of the dielectric layer (gate insulting layer) corresponding to the parasitical capacitor, the area s of the part in which both of these two electrodes faces each other as well as the distance d therebetween are fixed. Also, the voltages of the gate electrode and the drain electrode of thin film transistor TFT5 are also fixed. Therefore the capacitance value c_{gd2}, of the capacitor C_{gd2} is also a fixed value.

ct represents the capacitance value of the second capacitor Cₜ between the extension portion 331 of the storage capacitor electrode line and the touch control electrode 342. The dielectric constant ε of the dielectric layer (gate insulating layer and the passivation layer) corresponding to the second capacitor Cₜ, the area s of the part in which both of these two electrodes face each other as well as the distance d there between are fixed. Also, the voltages on the touch control electrode and the extension portion 331 of the storage capacitor electrode line are also fixed under normal condition (that is the condition that no external force is applied to the liquid crystal panel). Therefore the capacitance value cₜ of the capacitor Cₜ is also a fixed value under normal condition.

cref represents the capacitance value of the reference capacitor C_{ref} between the touch control electrode 342 and the contraposition electrode 414. Its dielectric layer is alignment layer 404, 415 as well as the liquid crystal layer 416. Here, the voltages on the touch control electrode and the extension portion 331 of the contraposition electrode are also fixed under the normal condition (that is the condition that no external force is applied to the liquid crystal panel).

Under normal condition, no external force is applied to the color filter substrate. Therefore, the distance between the color filter and the array substrate remains unchanged because of the spacer 417. Hence, the capacitance value cgd2 of the parasitical capacitor C_{gd2}, the capacitance value c_{ref} of the reference capacitor C_{ref} and the capacitance value ct of the storage capacitor Cₜ are all fixed in the normal condition. It can be seen from expression (2) that, when all of the values are fixed, the detecting voltage Vₒᵤₜ (i.e. the voltage sustained by the touch control electrode) output by the signal detecting line 39 is also fixed. In this regard, the value that is detected by the peripheral detector (not shown) is also a normal value Vₒᵤₜ (or an amplified voltage signal).

Referring to FIG. 8, when an external force is applied to the color filter substrate, the distance between the portion of the color filter substrate where the force is applied and the array substrate becomes smaller and the value of the reference capacitance C_{ref} increases. With reference to expression (1), when the value of the reference capacitor C_{ref} increases, the voltage sustained on the touch control electrode (here referred as Vₒᵤₜ′) also increases. Hence, when the scan line G1 is scanned during the n+1th frame, the thin film transistor TFT5 is turned on. The voltage sustained on the touch control electrode 342 is transmitted to the signal detecting line 39 through the thin film transistor TFT5, while the peripheral detector detects a abnormal or increased voltage signal Vₒᵤₜ′ (or a amplified voltage signal).

In the present embodiment, the converter can also be set up to input reference voltage in more than one frame and output the detecting voltage in one frame (for example, input the reference voltage during the n-th frame and the n+1th frame, output the detecting voltage during the n+2th frame) so as to ensure there is enough time to charge the second storage capacitor sufficiently. In addition, because every frame lasts a very short period of time, the external force applied on the touch control liquid crystal display will be detected during more frames scans. Therefore, during these frames, at least one process including inputting a reference voltage and outputting a detecting voltage can be finished, which ensures that the detector can detect the change of the voltage signal.

The detecting step here is similar to the first embodiment. As such, details of the detecting step are not repeated.

Because the scan lines are scanned sequentially, and the detector can detect the output signal through signal detecting line 39 only when thin film transistor TFT5 is turned on, so when an abnormal or high voltage signal is detected, the coordinate position where the external force is applied to the color filter substrate can be determined immediately (the row where thin film transistor TFT5 is located is the abscissa and the column where the signal detecting line is located is the ordinate).

It can be seen from the present embodiment that since the reference capacitance C_{ref} is changed by altering the distance between the array substrate and the color filter substrate, the voltage sustained on the touch control electrode (that is the detecting voltage) will be changed accordingly. Therefore, it can be determined whether there is any external force applied on the liquid crystal panel by detecting the detecting voltage, and furthermore, the coordinate of the location where the external force is applied can also be determined.

Those skilled in the art will understand that when an external force is applied, the sensitivity of detecting the external force on the touch control liquid crystal display can be increased by increasing the amount of capacitance change of the reference capacitor C_{ref}. Therefore, in one exemplary, embodiment, the distance between the touch control electrode 342 and the contraposition electrode 414 may be decreased. For example, a protuberance may be provided at the position on the color filter corresponding to the touch control electrode and the contraposition electrode is further provided on the protuberance, so that the distance between the contraposition electrode and the touch control electrode decreases. The distance between the contraposition electrode and the touch control electrode can also be decreased by providing the protuberance under the touch control electrode on the array substrate. Of course increasing the amount of capacitance change can also be achieved by other means as long as the distance between the contraposition electrode and the touch control electrode is smaller than the distance between the pixel electrode and the contraposition electrode.

According to the present embodiment, since the extra reference voltage input line is not more needed, the aperture ratio is significantly increased. Simultaneously the load of the scan line can also be significantly decreased because of the reduction of thin film transistor installment.

Those skilled in the art can understand that the arrangement of signal detecting line 39 is illustrative, wherein the signal detecting line 39 can also be provided to be parallel to scan line. Similarly, the arrangement of the converter is also illustrative. The detector and the converter can also be integrated into the array substrate, or disposed on the printing circuit board on the peripheral array substrate.

In the present embodiment, the number of the detecting points of the external force (i.e. the pixels correspond to the signal detecting line 39 and touch control electrode) can be provided as required. That is, they can be disposed all over the whole panel, or only disposed in some pixels, some pixel rows or some pixel columns. However, to guarantee the display quality of the whole panel, the aperture ratio of every pixel is kept the same. That is, some pixel areas should be covered by the black matrixes because the pixels include touch control electrodes. As a result, the aperture ratio of these areas with touch control electrodes decreases. On the other hand, some other pixels (without touch control electrodes) are also covered by the black matrixes to ensure the aperture ratio of the pixels which are have touch control electrodes is the same as the aperture ratio of the pixels which do not have touch control electrodes.

What is claimed is,

1. A touch control liquid crystal display array substrate, comprising:
a plurality of scan lines,
a plurality of data lines perpendicular to the plurality of scan lines and further which together with the scan lines define a pixel area,
a pixel electrode formed in the pixel area,
a storage capacitor electrode line forming a first storage capacitor with the pixel electrode,
a first switching element through which the data line inputs a data signal to the pixel electrode,
a signal detecting line,
a touch control electrode formed in the pixel area and forming a second storage capacitor with the storage capacitor electrode line,
a second switching element configured to selectively input a voltage signal from the signal detecting line to the touch control electrode and output an output voltage signal from the touch control electrode to the signal detecting line.

2. The array substrate according to claim 1, wherein the first switching element is a thin film transistor, of which a gate electrode is electrically connected to the scan line, a source electrode is electrically connected to a data line and a drain electrode is electrically connected to the pixel electrode; and
wherein the second switching element is a thin film transistor, of which a gate electrode is electrically connected to the scan line, a source electrode is electrically connected to the signal detecting line, and a drain electrode is electrically connected to the touch control electrode.

3. The array substrate according to claim 1, wherein the storage capacitor electrode line further comprises an extension portion, with which the touch control electrode forms a second storage capacitor.

4. The array substrate according to claim 1, wherein both the touch control electrode and the pixel electrode are made of transparent conductive material.

5. The array substrate according to claim 2, wherein the signal detecting line is arranged to be parallel to the data line.

6. A touch control liquid crystal display comprising:
an array substrate,
a color filter substrate,
and a peripheral circuit,
wherein the array substrate comprises:
a plurality of scan lines,
a plurality of data lines perpendicular to the plurality of scan lines and further defining a pixel area,
a pixel electrode formed in the pixel area,
a storage capacitor electrode line forming a first storage capacitor with the pixel electrode,
a first switching element through which the data line inputs a data signal to the pixel electrode,
a signal detecting line,
a touch control electrode formed in the pixel area and forming a second storage capacitor with the storage capacitor electrode line, and
a second switching element through which configured to selectively input an input voltage signal from the signal detecting line to the touch control electrode and output an output voltage signal from the touch control electrode to the signal detecting line;
the color filter substrate includes a contraposition electrode,
the peripheral circuit further comprises a converter for controlling the input and output voltage signal on the signal detecting line.

7. The display according to claim 6, wherein the first switching element is a thin film transistor, of which a gate electrode is electrically connected to the scan line, a source electrode is electrically connected to the data line, and a drain electrode is electrically connected to the pixel electrode; and
wherein the second switching element is a thin film transistor, of which a gate electrode is electrically connected to the scan line, a source electrode is electrically connected to the signal detecting line, and a drain electrode is electrically connected to the touch control electrode.

8. The display according to claim 6, wherein the storage capacitor electrode line further comprises an extension portion, with which the touch control electrode forms a second storage capacitor.

9. The display according to claim 6, wherein both the touch control electrode and the pixel electrode are made of transparent conductive material.

10. The display according to claim 6, wherein the signal detecting line is arranged to be parallel to the data line.

11. The display according to claim 6, wherein the pitch between the touch control electrode and the contraposition electrode is smaller than that between the pixel electrode and the contraposition electrode.

12. The display according to claim 6, wherein the peripheral circuit comprises a detector for detecting the input or output voltages of the signal detecting line.

13. The display according to claim 6, wherein the color filter substrate comprises a black matrix covering the area where the touch control electrode is located.

14. The display according to claim 13, wherein each pixel area covers an area as large as the area where the touch control electrode is located.
